(19) United States
(12) Patent Application Publication
(10) Pub. No.: US 2025/0053932 A1
(43) Pub. Date: Feb. 13, 2025

(54) SYSTEMS AND METHODS FOR GENERATING CONFIGURATIONS

(71) Applicant: Capital One Services, LLC, McLean, VA (US)

(72) Inventor: David WOLF, Richmond, VA (US)

(73) Assignee: Capital One Services, LLC, McLean, VA (US)

(21) Appl. No.: 18/447,773

(22) Filed: Aug. 10, 2023

(51) Int. Cl. G06Q 10/1093

(52) U.S. Cl. CPC G06Q 10/1095

(57) ABSTRACT

Systems and methods for obtaining a transmission of a first data packet, requesting one or more available physical locations based on the first data packet, determining the first configuration based on the first data packet and the one or more available physical locations, and causing to output the first configuration to a user interface.

### TECHNICAL FIELD

Various embodiments of this disclosure relate generally to generating one or more configurations and, more particularly, to systems and methods for determining in-person and/or virtual configurations with predicted member availabilities and/or locations.

### BACKGROUND

Conventional methods of configuration generation often involve inaccurate or unreliable determinations that ultimately result in dissatisfaction with the configuration. For example, even if a user (e.g., a scheduler) knows that a meeting will have virtual attendees, the user may not be immediately aware of what spaces would enable both in-person and virtual attendance. Further, given the rise in the number of virtual attendees-even to meetings some virtual attendees could realistically attend in person-efficiently, reliably, and cost-effectively predicting in-person or virtual attendance for a given individual is nearly impossible. These difficulties often lead to disorganized, inefficient, expensive, and/or potentially embarrassing complications.

This disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating one or more configurations.

In one aspect, a method for generating a first configuration is disclosed. The method may include obtaining a transmission of a first data packet, the first data packet including one or more paired start times and end times, a number of in-person slots, a number of virtual slots, and one or more technical capabilities; requesting, from a memory, one or more available physical locations based on the first data packet, wherein the one or more available physical locations is selected from a plurality of physical locations; determining, via a trained machine learning model, the first configuration based on the first data packet and the one or more available physical locations; and causing to output the first configuration to a user interface.

In another aspect, a method for generating a first configuration is disclosed. The method may include obtaining a transmission of a first data packet, the first data packet including one or more paired start times and end times, a number of in-person slots, a number of virtual slots, and one or more technical capabilities; obtaining a transmission of a second data packet, the second data packet including a plurality of physical locations, availability data associated with each of the plurality of physical locations, and technical capabilities associated with each of the plurality of physical locations; determining, via a trained machine learning model, a first configuration based on the first data packet and the second data packet; and causing to output the first configuration to a user interface.

In another aspect, a system is disclosed. The system may include at least one memory storing instructions; and at least one processor executing the instructions to perform operations for generating a first configuration. The operations may include: obtaining a transmission of a first data packet, the first data packet including one or more paired start times and end times, a number of in-person slots, a number of virtual slots, and one or more technical capabilities; requesting, from a memory, one or more available physical locations based on the first data packet, wherein the one or more available physical locations is selected from a plurality of physical locations; determining, via a trained machine learning model, the first configuration based on the first data packet and the one or more available physical locations; and causing to output the first configuration to a user interface.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating one or more configurations, according to one or more embodiments.

FIG. 2 depicts an exemplary method for generating one or more configurations, according to one or more embodiments.

FIG. 3 depicts an example machine learning training flow chart, according to some embodiments of the disclosure.

FIG. 4 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

As used herein, the term “member” or the like generally encompasses a meeting attendee. As used herein, the term “configuration” or the like generally encompasses an arrangement of data based on one or more requirements, preferences, availabilities, etc. For example, a configuration may include a paired start time and end time, a location, a number of in-person members, and a number of virtual members for a meeting.

In an exemplary use case, a user may desire to schedule a meeting. The user may provide a configuration system with portfolio data relating to the one or more available spaces for reservation. The portfolio data may include information such as the number of spaces, the technical capabilities of each space, standing and/or sitting room of each space, etc. The user may also provide a configuration system with parameter data. The parameter data may include information for scheduling a meeting, such as when the meeting will be, expected attendance number and/or method (e.g., in-person, virtual, telephonic, etc.), what technical capabilities are required (e.g., based on expected virtual attendance, demonstration or visualization of information, etc.), etc. The expected attendance number and/or method may be predicted by the configuration system, e.g., using a trained machine learning model. Based on the portfolio data, e.g., spaces, technologies, etc., available to choose from, the configuration system may determine one or more possible configurations of time, place, method, technology, etc. The configuration system may rank the one or more configurations based on one or more methods, such as how closely the respective configurations match the parameter data. The configuration system may check and/or monitor the one or more configurations to determine if any issues are present, such as time conflicts, unsatisfied parameter data, etc.

It should also be understood that the examples above are illustrative only. The techniques and technologies of this disclosure may be adapted to any suitable activity and/or technique. Presented below are various systems and methods of generating one or more configurations.

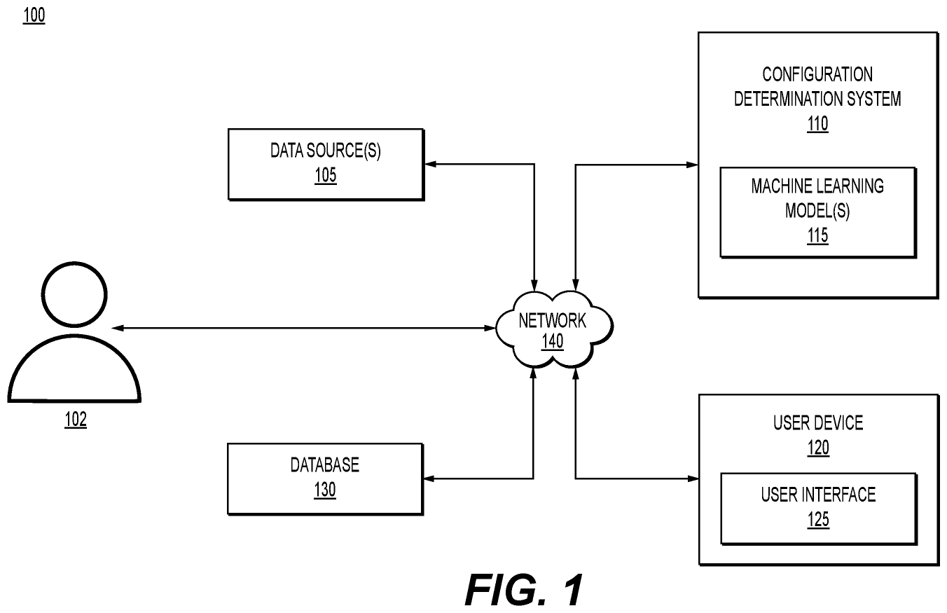

FIG. 1 depicts an exemplary environment for generating one or more configurations, according to one or more embodiments. Environment 100 of FIG. 1 depicts a user 102, one or more data sources 105, a Configuration Determination System (hereinafter “Configuration System”) 110, a user device 120, a database 130, and a network 140.

The one or more data sources 105 may be configured to obtain inputs of data and/or metadata, e.g., as one or more data packets. The data and/or metadata may include portfolio data and/or metadata, member data and/or metadata, parameter data and/or metadata, etc. The one or more data sources 105 may receive inputs from other aspects of environment 100, e.g., configuration system 110, user device 120, database 130, etc., and/or from other sources, e.g., third-party systems. For example, the one or more data sources 105 may obtain physical location data from a third-party database or server that may be implementing the physical location data. The one or more data sources 105 may transmit data to other aspects of environment 100, e.g., to configuration system 110, user device 120, database 130, etc.

Portfolio data may include the spaces and capabilities of those spaces that user 102 may be able to reserve, such as spaces available to host meetings, the capacity of the spaces available to host meetings, technical capabilities and amenities (hereinafter “technical capabilities”) of the spaces available to host meetings, third-party rentable spaces (e.g., in proximity to one or more members), etc. For example, Business A's portfolio data may include 3 buildings, each with 12 spaces available for hosting meetings. Technical capabilities may include one or more of telephones, televisions, whiteboard, blackboard, or chalkboard, video conferencing, content sharing, food service, accessibility features (e.g., bathrooms, sinks, etc.), other features, etc. Portfolio data may be determined via one or more application programming interfaces (APIs).

Member data may include one or more of member calendar data (e.g., upcoming appointments, pre-set working location, etc.), check in/out data (e.g., whether a member has swiped their badge at a check-in/check-out system within a certain time frame), member residences, member working location(s), historical member meeting locations and/or methods (e.g. in-person, virtual, etc.), preferred member attendance methods, member technological capabilities (e.g., telephone, web streaming, etc.), provided member locations (e.g., a location the member has affirmatively identified, such as in-person or virtual), etc. In some techniques, an API may be used to pull the member calendar data, e.g., the location of each member based on the member's personal calendar. The API may use existing features in calendar applications, where the member may set their working location. In some techniques, an API may be used to output member data via a third party application integration, e.g., Google Calendar, Microsoft Outlook, a desktop client, an internet application, a physical display, a computer, etc.

Member data may be collected and/or stored by one or more aspects of environment 100, e.g., one or more data sources 105, user device 120, database 130, etc. The collected member data may be used for analytics, as discussed in more detail below. Further, collected member data may be used to determine the actual location of the member on a relevant day, e.g., via integration with other systems. For example, environment 100 may be integrated with a check-in/check-out system, such that if the member swipes an identification card at the check-in/check-out system, the location of the member may be determined based on the swipe of the identification card at the check-in/check-out system.

Parameter data may include one or more of: one or more start times and end times (e.g., paired start times and end times), one or more physical locations, one or more technical capabilities, availability data, a number of in-person slots, a number of virtual slots, one or more member meeting preferences, one or more member meeting locations, a member listing, etc. The member listing may include one or more members (e.g., employees, guests, individuals, etc.) invited and/or intended to be invited to a meeting.

The start times and end times may include the expected, desired, anticipated, required, etc. start time(s) and/or end time(s) of a meeting. The start times and end times may be based on and/or determined at least in part on duration. For example, it may be determined that a 1-hour meeting that has a start time of 10 AM will have an end time of 11 AM. The start times and end times may be associated with one or more characteristics, such as required, optional, preferred, etc. For example, a required end time may be “required before 2 PM,” “required at 2 PM,” “preferred before 2 PM,” “preferred at 2 PM,” etc.

The one or more physical locations may include a number of reservable (available to reserve) spaces in a building, a number of reservable buildings, etc. For example, Building A may have 12 spaces, 6 of which are reservable. The spaces and/or buildings considered reservable may be customized by user 102, e.g., based on one or more features such as technical capabilities. Continuing the prior example, User 1 may consider 4 spaces reservable based on the availability of both a coffee maker and televisions, and User 2 may consider 6 spaces reservable based on the availability of televisions.

The one or more technical capabilities may include the technology included in one or more of the physical locations. The technology may include one or more of televisions, Bluetooth, outlets (e.g., Universal Serial Bus (USB), socket(s), etc.), connection cables (e.g., USB, High-Definition Multimedia Interface (HDMI), etc.), speaker(s), projection screen, etc.

The availability data may include the availability of the one or more physical locations (e.g., whether a space is in use during a given start time and end time), the one or more in-person slots, the one or more members (e.g., a scheduling conflict such as whether a member is in a meeting during a given start time and end time), available refreshments (e.g., vending machine, coffee maker, catering space, etc.), etc.

The number of in-person slots may include the number of useable slots in the one or more physical locations for one or more members. The number of available slots may be determined based on one or more of a number of seats available in a physical location, standing room in a physical location (e.g., how many people may be able to fit in the physical location while standing), fire codes for space capacity or the like, etc.

The number of virtual slots may include the number of virtually useable slots for one or more members. The number of virtually useable slots may be determined based on network or software/account requirements. For example, a meeting with 100 virtually attending members may require a higher bandwidth than a meeting with 10 virtually attending members.

The one or more member meeting preferences and/or habits may include the one or more members' preferences related to start times and end times, the one or more physical locations, the one or more technical capabilities, the availability data, etc.

The one or more member meeting locations may include the locations from which the one or more members attend the meeting. In some techniques, members may be associated with pre-determined meeting locations, e.g., virtual or in-person.

Configuration system 110 may be configured as a browser plug-in and/or application plug-in. For example, configuration system 110 may be configured as a browser plug-in, e.g., within a web browser, and/or may be configured as an application plug-in, e.g., within an application on a device, e.g., within an application on user device 120. Configuration system 110 may be configured to determine one or more configurations. Configuration system 110 may be configured to obtain data from any suitable aspect of environment 100, e.g., one or more data sources 105, user device 120, database 130, etc. Configuration system 110 may be configured to determine one or more configurations via one or more machine learning model(s) 115. Configuration system 110 and/or the one or more machine learning model(s) 115 may be configured to transmit data, e.g., the outputs of the one or more machine learning model(s) 115, to any suitable aspect of environment 100, e.g., one or more data sources 105, user device 120, database 130, etc.

In some techniques, the one or more machine learning model(s) 115 may include a trained meeting location machine learning model. The trained meeting location machine learning model may be configured to determine the member meeting locations. An example method for training and/or using the trained meeting location machine learning model is described in more detail below.

In one embodiment, the trained meeting location machine learning model is configured for unsupervised machine learning that does not require training using known outcomes, e.g., correct responses. Unsupervised machine learning utilizes machine learning algorithms to analyze and cluster unlabeled datasets and discover hidden patterns or data groupings, e.g., similarities and differences within data, without supervision. In one example embodiment, the unsupervised machine learning implements approaches that includes clustering (e.g., deep embedded clustering, K-means clustering, hierarchical clustering, probabilistic clustering), association rules, classification, principal component analysis (PCA), or the like. The trained meeting location machine learning model utilizes the unsupervised machine learning techniques to predict one or more member meeting locations.

In one embodiment, the trained meeting location machine learning model is additionally or alternatively configured for supervised machine learning that utilizes training data, e.g., historical meeting location, real-time member location, member residence address, etc., for training a machine learning model configured to predict one or more member meeting locations. In one example embodiment, the trained meeting location machine learning model performs model training using training data that contains input and correct output, to allow the model to learn over time. The training is performed based on the deviation of a processed result from a documented result when the inputs are fed into the machine learning model, e.g., an algorithm measures its accuracy through the loss function, adjusting until the error has been sufficiently minimized. In one embodiment, the trained meeting location machine learning model randomizes the ordering of the training data, visualizes the training data to identify relevant relationships between different variables, identifies any data imbalances, and splits the training data into two parts where one part is for training a model and the other part is for validating the trained model, de-duplicating, normalizing, correcting errors in the training data, and so on. The trained meeting location machine learning model implements one or more machine learning techniques, e.g., K-nearest neighbors, cox proportional hazards model, decision tree learning, association rule learning, neural network (e.g., recurrent neural networks, graph convolutional neural networks, deep neural networks), inductive programming logic, support vector machines, Bayesian models, Gradient boosted machines (GBM), LightGBM (LGBM), Xtra tree classifier, etc.

In some techniques, the one or more machine learning model(s) 115 may include a trained slot determination machine learning model. The trained slot determination machine learning model may be configured to determine a number of in-person slots, a number of available in-person slots, a number of virtual slots, a number of available virtual slots, a number of members that reserved their attendance but did not attend (e.g., “no shows”), etc. The trained slot determination machine learning model may use one or more analytics (as discussed in more detail below) to determine the number of in-person slots, the number of available in-person slots, the number of virtual slots, the number of available virtual slots, the number of “no shows,” etc. The trained slot determination machine learning model may be trained and/or used via one or more of the methods described herein.

In some techniques, the one or more machine learning model(s) 115 may include a trained issue machine learning model. The trained issue machine learning model may be configured to determine one or more issues associated with one or more configurations, e.g., based on issue data, to predict resolutions, and/or modify the one or more configurations based on the issue data. Issue data may include one or more of: time conflicts (e.g., based on member availability, the paired start time and end time, etc.), space usability data (e.g., unexpected power outages, non-functional air conditioning or heating, etc.), resolution data (e.g., whether a space is or has been returned to a state of functionality), unavailable parameters, updated slot requirements, changes in member, space, and/or technological availability, determined “no shows,” etc. The unavailable parameters may include one or more of unavailable combinations, unavailable required technical capabilities (e.g., accessible restrooms), etc. The updated slot requirements may include changes in the expected or predicted slot requirements. For example, if 9 members reserve to be in-person and 11 members reserve to be virtual, a 10-seat space with web streaming may be reserved. If 2 members later reserve to be in-person, an updated slot requirement may be determined and a 15-seat space may be alternatively reserved. The changes in member, space, and/or technological availability may include changes in technical capabilities, such as malfunctioning telephone, video conferencing, projector, etc. The trained issue machine learning model may be trained and/or used via one or more of the methods described herein. The determined “no shows” may include the number of members that reserved their attendance but did not attend, e.g., as determined by the trained slot determination machine learning model. In some techniques, if a given number of in-person members are “no shows,” the trained issue machine learning model may be configured to modify the one or more configurations based on the determined “no shows.”

In some techniques, one or more configurations may be ranked using a ranking function and/or a trained machine learning model. The ranking function may be one or more of a competition ranking (e.g., a standard competition ranking, a modified competition ranking, etc.), a dense ranking, an ordinal ranking, etc. In some techniques, the one or more machine learning model(s) 115 may include a trained ranking machine learning model. The trained ranking machine learning model may be configured to determine a ranking of one or more configurations. For example, the trained ranking machine learning model may rank one or more configurations based on how closely each one of the one or more configurations matches a data packet. The trained ranking machine learning model may be trained and/or used via one or more of the methods described herein.

In some techniques, the one or more machine learning model(s) 115 may include a trained configuration machine learning model. The trained configuration machine learning model may be configured to determine one or more configurations. The trained configuration machine learning model may be trained and/or used via one or more of the methods described herein.

One or more of the various models described herein (e.g., the trained meeting location machine learning model, the trained slot determination machine learning model, the trained issue machine learning model, the ranking function, the trained ranking machine learning model, the trained configuration machine learning model, etc.) may be stored in configuration system 110 and/or provided thereto by another aspect of environment 100 (e.g., one or more data sources 105, user device 120, database 130, etc.) and/or a third-party system.

User device 120 may be configured to receive one or more inputs and/or to output one or more configurations, e.g., via user interface 125. For example, user device 120 may be configured to receive one or more inputs from user 102 interacting with a user interface 125. User device 120 may be configured to receive data from any suitable aspect of environment 100, e.g., from the one or more data sources 105, configuration system 110, database 130, etc. User device 120 may be configured to transmit data to any suitable aspect of environment 100, e.g., to the one or more data sources 105, configuration system 110, database 130, etc. In some embodiments, environment 100 may include more than one user device 120. For example, a first user device may be configured to obtain a request to generate a configuration, e.g., via a first user interface, and a second user device may be configured to cause the generated configuration to be outputted, e.g., via a second user interface.

Database 130 may be configured to store data, e.g., portfolio data, member data, parameter data, etc. Database 130 may be configured to obtain data from one or more components of environment 100, e.g., from the one or more data sources 105, configuration system 110, user device 120, etc. Database 130 may be configured to transmit data to one or more components of environment 100, e.g., to the one or more data sources 105, configuration system 110, user device 120, etc.

One or more of the components in FIG. 1 may communicate with each other and/or other systems, e.g., across network 140. In some embodiments, network 140 may connect one or more components of environment 100 via a wired connection, e.g., a USB connection between the one or more data sources 105 and database 130. In some embodiments, network 140 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, database 130 may be integrated in configuration system 110. In another example, configuration system 110 may further include a storage system, e.g., database 130, which may store portfolio data, member data, parameter data, and/or other relevant data. In some embodiments, operations or aspects of one or more of the components discussed above may be distributed amongst one or more other components. For example, configuration system 110 may be integrated into an extant scheduling system. Any suitable arrangement and/or integration of the various systems and devices of the environment 100 may be used.

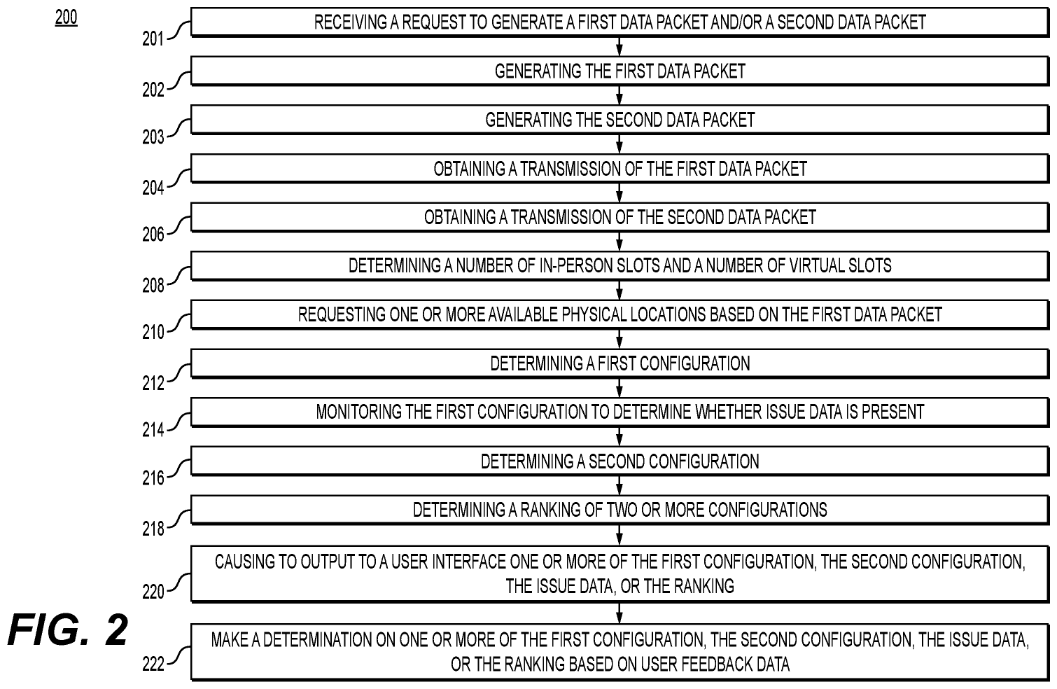

FIG. 2 depicts an exemplary method 200 for generating one or more configurations, according to one or more embodiments. At step 201, optionally, a request to generate a first data packet, e.g., a parameter data packet, and/or a second data packet, e.g., a portfolio data packet, may be received. For example, user 102 may enter a request to generate the parameter data packet and/or the portfolio data packet via user interface 125.

In some techniques, the request to generate the parameter data packet may be based on receipt of parameter data, e.g., parameter data inputted by user 102 via user interface 125. The request to generate the parameter data packet may be automatically generated based on one or more of parameter data being received (e.g., at user interface 125), the content of the parameter data received, etc.

In some techniques, the request to generate the portfolio data packet may be based on portfolio data. In some techniques, the request to generate the portfolio data packet may be based on receipt of parameter data, e.g., parameter data inputted by user 102 via user interface 125, portfolio data, the type of data received (e.g., parameter data, portfolio data, member data, etc.), etc. The request to generate the portfolio data packet may be automatically generated.

At step 202, the parameter data packet (e.g., the first data packet) may be generated. The parameter data packet may be generated to include at least the parameter data obtained, e.g., from user 102.

At step 203, the portfolio data packet (e.g., second data packet) may be generated. The portfolio data packet may be generated based on the portfolio data obtained, e.g., from user 102, database 130, etc. For example, the portfolio data packet may be generated based on portfolio data stored in a database, e.g., database 130.

At step 204, a transmission of the parameter data packet may be obtained. For example, the parameter data packet may be obtained at configuration system 110. At step 206, optionally, a transmission of the portfolio data packet may be obtained. For example, the portfolio data packet may be obtained at configuration system 110. In some techniques, one or both of the parameter data packet or the portfolio data packet may have been received prior to the start of method 200. For example, one or both of the parameter data packet or the portfolio data packet may have been received and stored in database 130 for later use prior to initiation of step 202.

At step 208, optionally, a number of in-person slots and a number of virtual slots may be determined. The number of in-person slots and the number of virtual slots may be determined via one or both of the parameter data packet and/or the trained slot determination machine learning model. For example, the number of in-person slots and the number of virtual slots may be determined by the member listing of the parameter data packet.

In some techniques, the number of in-person slots and the number of virtual slots may be determined by the trained slot determination machine learning model. The trained slot determination machine learning model may be trained to infer the number of in-person slots and the number of virtual slots based on one or more of the member data, the portfolio data, and/or the parameter data. For example, the trained slot determination machine learning model may be trained to predict that, of 50 expected members, 30 members may be in-person and 20 members may be virtual. In another example, the trained slot determination machine learning model may be trained to predict that, of the 30 members expected and/or reserved to be in person, 3 members will be virtual. As discussed herein, any suitable machine learning techniques may be used, e.g., transformer, K-means clustering, etc. In some techniques, the trained slot determination machine learning model may determine how many members did not attend the meeting despite reserving their attendance for the meeting.

At step 210, one or more available physical locations may be requested and/or reserved (e.g., temporarily reserved pending user 102 approval). In some techniques, the one or more available physical locations may be requested based on the parameter data packet and/or selected from a plurality of physical locations. For example, Business B may have a portfolio of 40 available spaces, but based on the parameter data of the parameter data packet, only 3 available physical locations, e.g., based on the in-person and/or virtual slots, the technical capabilities, the start times and/or end times, etc.

At step 212, a first configuration may be determined. The first configuration may include one or more recommended spaces based on one or more of location (e.g., whether one or more recommended spaces are central to the members in a building, in an state, in a country, etc.), number of in-person slots, number of virtual slots, technical capabilities, as determined based on one or more of the data from steps 201-210. For example, if method 200 determines there are members in numerous locations that may be in person, the first configuration may include recommended spaces in more than one physical location. Upon determining the first configuration, the one or more spaces may be reserved, e.g., using one or more existing systems.

In some techniques, the first configuration may be determined by a trained machine learning model, e.g., trained configuration machine learning model. The trained configuration machine learning model may be trained to predict one or more configurations based on one or more of portfolio data (e.g., the portfolio data packet (see step 203)), member data, and/or parameter data (e.g., the parameter data packet (see step 202)), the determined number of in-person slots and/or the determined number of virtual slots (see step 208), the one or more available physical locations (see step 210), etc.

In some techniques, a number of “no shows” associated with a member (e.g., historical member “no shows”), a physical location, a virtual location, etc. may be used in determining the first, second, third, etc. configuration. For example, if a high number of “no shows” is associated with a first physical location, a notification of the “no show” rate may be provided to user 102, e.g., via user interface 125. In another example, if a high number of “no shows” is associated with a first physical location, the first physical location may be excluded from the determination of the first configuration.

As discussed herein, any suitable machine learning techniques may be used, e.g., transformer, K-means clustering, etc. The trained configuration machine learning model may generate a report, e.g., a daily report, based on the determined configuration. The report may be output, e.g., via user interface 125.

At step 214, optionally, the first configuration may be monitored to determine whether issue data is present. Issue data may include one or more conflicts (e.g., based on initial availability data, updated availability data, etc.), malfunction data (e.g., malfunctioning air conditioning, video conferencing, etc.), updated data (e.g., the member locations change from the initial determination), etc. Updated data may include data that one or both of user 102 or one or more members is no longer with the organization requesting the configuration. For example, if method 200 determines that a first user 102 is no longer with the organization requesting the configuration, the outputs of step 220 and/or 222 (discussed below) may be output to a second user 102, e.g., via a user device 120 associated with the second user 102. In another example, if method 200 determines that a first member is no longer with the organization requesting the configuration, the slot reserved for the first member may be canceled, transferred to a second member, released, etc.

In some techniques, the first configuration may be monitored for issue data on a regular basis, e.g., daily, weekly, hourly, etc. If issue data is not determined to be present, the first configuration may be confirmed. If issue data is determined to be present, the first configuration may be modified and/or a new configuration may be determined. For example, if a physical location is initially available, but becomes unavailable (e.g., due to a leaking roof), issue data may be determined present and the first configuration may be modified and/or a new configuration may be determined. In another example, if issue data is determined to be present, user 102 may be notified (as discussed in steps 220-222 below) of the issue data and may instruct method 200 to generate a second configuration, as discussed in more detail below.

In some techniques, the trained issue machine learning model may determine whether issue data is present and/or, upon determining issue data is present, suggest one or more modifications and/or redeterminations of the first configuration. The trained issue machine learning model may generate utilization reports and predictive forecasts, which may be utilized in determining whether issue data is present and/or, upon determining issue data is present, suggesting one or more modifications and/or redeterminations of the first configuration.

At step 216, optionally, a second configuration may be determined. The second configuration may be determined based on the data of step 212 and/or based on the presence of issue data (see step 214). In some techniques, the second configuration may be determined by a trained machine learning model, e.g., the trained configuration machine learning model. The second configuration may be determined based on the data of step 212 as an additional and/or alternative configuration. For example, if more than one configuration is possible, the first configuration and the second configuration may be determined.

The second configuration may be determined based on the data of step 214. For example, if all of the in-person members are determined to be “no shows,” or all are attending virtually instead of in-person, the trained issue machine learning model may update the one or more configurations to remove in-person slots, and retain and/or increase the number of virtual slots. The trained issue machine learning model may cancel the reservation for the in-person slots, e.g., at a physical location. Advantageously, an unused physical location may be released from a configuration (e.g., from a reservation) automatically, reducing the amount of waste (e.g., energetic waste, time waste, etc.) associated with an unused physical location, and preventing underutilization of spaces.

It should be noted that any suitable number of configurations may be determined, e.g., one configuration, two configurations, three configurations, five configurations, ten configurations, etc. In some techniques, the second configuration may be determined based on the presence of issue data. For example, if issue data is determined based on the first configuration, a second configuration may be determined.

At step 218, optionally, a ranking of two or more configurations may be determined. In some techniques, the ranking may be determined by a ranking function, as discussed herein. In some techniques, the ranking may be determined by a trained machine learning model, e.g., the trained ranking machine learning model. The trained ranking machine learning model may be trained to rank two or more configurations based on one or more of the parameter data packets, the one or more available physical locations, etc. The ranking may be based on a determined configuration match to the parameter data packet. The configuration match may be determined by comparing a configuration to at least the parameter data packet. As discussed herein, any suitable machine learning techniques may be used, e.g., transformer, K-means clustering, etc.

In some techniques, the ranking may be determined by a weighing system. Certain aspects (e.g., optional aspects, required aspects, preferred aspects, etc.) may have different weights, which may be customizable by user 102. For example, a required aspect may be weighed more than a preferred aspect, a preferred aspect may be weighed more than an optional aspect, etc.

In some techniques, the ranking may be determined by a point system. Each configuration may be compared to data, e.g., the data of the parameter data packet and/or the one or more available physical locations, to determine how closely each configuration aligns to the data. Aspects (e.g., start time, end time, television capability, etc.) that are satisfied by a given configuration may receive points based on whether the aspect is required (e.g., 3 points per required aspect met), preferred (e.g., 2 points per aspect met), additional (e.g., 1 point per aspect met) etc. For example, if the data has 5 required aspects and 2 preferred aspects, a first configuration may have 17 points if it satisfied 4 required aspects and 1 preferred aspect and a second configuration may have 20 points if it satisfied 5 required aspects and 0 preferred aspects. In this example, the second configuration may be ranked higher than the first configuration. In some techniques, the determined points may be used by the weighing system (discussed above) to determine the ranking. For example, a configuration with 20 points may be weighed more than a configuration with 17 points.

At step 220, the system hosting the configuration system may cause to output one or more of the first configuration, the second configuration, the issue data, or the ranking, e.g., to user interface 125.

At step 222, the system hosting the configuration system may make a determination (e.g., confirm, reject, partially confirm, partially reject, determine analytics, etc.) on one or more of the first configuration, the second configuration, the issue data, or the ranking based on obtained user feedback data. User feedback data may be obtained via user interface 125, e.g., user 102 interacting with user interface 125, such that user 102 may provide a response to the output one or more first configuration, second configuration, issue data, or ranking. Based on the determination, one or more reservations may be generated by a reservation system, e.g., based on one or more of the first configuration, the second configuration, the issue data, or the ranking. The reservation system may be integrated with any scheduling system.

In some techniques, the system hosting the configuration system may determine one or more analytics, e.g., expected member location, actual member location, technical capabilities requested, technical capabilities used, adjustment in one or more needs, etc. For example, if configuration system 110 predicted 30 in-person members and 10 virtual members, but the actual in-person members were 14 and the actual virtual members were 10, configuration system 110 may determine that a smaller in-person capacity may be required for subsequent configurations, e.g., configurations with similar parameters. An adjustment in one or more needs may be determined based on historical data (e.g., historical member meeting locations and/or methods, historical meeting location(s), historical member “no shows,” etc.) to identify in-person utilization and/or an adjustment. For example, configuration system 110 may use historical data to determine a need for more spaces with more or less member slots, underutilized amenities or technologies, where the demand for amenities, space, and/or technology may be higher than what is available, etc.

The one or more analytics may be determined using one or more sensors, e.g., cameras, speakers, motion sensors, check-in/check-out systems, etc., third party data, APIs, etc. The one or more sensors may identify members in a room and/or may identify if a member's phone, video system, etc. are connected virtually. Based on the determined analytics, the system hosting the configuration system may request a reservation be released, e.g., if it is determined that in-person members are not present, the meeting ends early, based on recurring meetings occurring with no members present, etc. In some techniques, if a reservation for a recurring meeting is released, a notification may be caused to be output, e.g., via user interface 125. The notification may include options, such as one or more of rescheduling the reservation, modifying the reservation, rejecting the request for the reservation to be released, accepting the request for the reservation to be released, etc. The one or more analytics, requests (e.g., the request for the reservation to be released), etc. may be stored, e.g., in database 130, and/or caused to be displayed via a web interface.

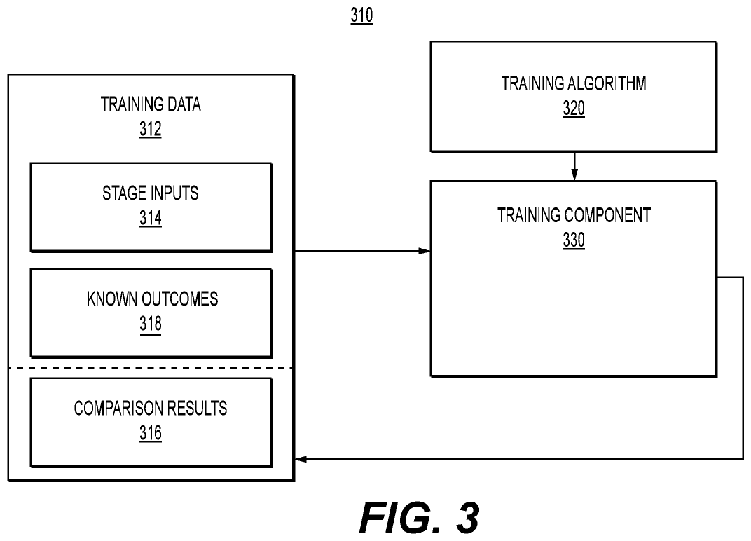

One or more implementations disclosed herein include and/or are implemented using a machine learning model, e.g., configuration system 110. For example, one or more of the engines of configuration system 110 are implemented using a machine learning model and/or are used to train the machine learning model. A given machine learning model may be trained using the training flow chart 310 of FIG. 3. The training data 312 includes one or more of stage inputs 314 and the known outcomes 318 related to the machine learning model to be trained. The stage inputs 314 are from any applicable source including text, visual representations, data, values, comparisons, and stage outputs, e.g., one or more outputs from one or more steps from FIG. 2. The known outcomes 318 are included for the machine learning models generated based on supervised or semi-supervised training. An unsupervised machine learning model is not trained using the known outcomes 318. The known outcomes 318 includes known or desired outputs for future inputs similar to or in the same category as the stage inputs 314 that do not have corresponding known outputs.

The training data 312 and a training algorithm 320, e.g., one or more of the modules implemented using the machine learning model and/or are used to train the machine learning model, is provided to a training component 330 that applies the training data 312 to the training algorithm 320 to generate the machine learning model. According to an implementation, the training component 330 is provided with comparison results 316 that compare a previous output of the corresponding machine learning model to apply the previous result to re-train the machine learning model. The comparison results 316 are used by the training component 330 to update the corresponding machine learning model. The training algorithm 320 utilizes machine learning networks and/or models including, but not limited to a deep learning network such as transformers, Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

The techniques disclosed in the present disclosure aim to minimize the problems discussed above, including improving accuracy and speed of the determination of one or more configurations. The techniques described herein may advantageously improve data processing, as the typical amount of data received prior to generating one or more data packets (e.g., a first data packet, a second data packet, etc.) may be quite large. Determination of the relevant data from which one or more data packets may be generated may improve the speed and accuracy of a determined configuration, a ranking of configurations, etc., as the computing power and resources required to perform the data analysis would be significantly reduced. Further, the implementation of at least one trained machine learning model may advantageously account for myriad data that are relevant in determining one or more configuration, the ranking of the one or more configurations, etc.

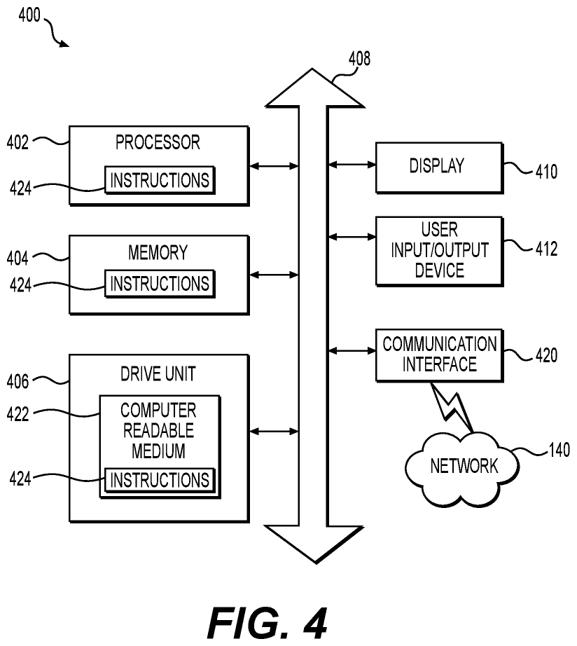

FIG. 4 depicts a simplified functional block diagram of a computer 400 that may be configured as a device for executing the methods disclosed here, according to exemplary embodiments of the present disclosure. For example, the computer 400 may be configured as a system according to exemplary embodiments of this disclosure. In various embodiments, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating a first configuration, the method comprising:
obtaining a transmission of a first data packet, the first data packet including one or more paired start times and end times, a number of in-person slots, a number of virtual slots, and one or more technical capabilities;
requesting, from a memory, one or more available physical locations based on the first data packet, wherein the one or more available physical locations is selected from a plurality of physical locations;
determining, via a trained machine learning model, the first configuration based on the first data packet and the one or more available physical locations; and
causing to output the first configuration to a user interface.

2. The method of claim 1, further comprising:
receiving, from a user, a request to generate the first data packet, the request including the one or more paired start times and end times, a member listing, and the one or more technical capabilities.

3. The method of claim 2, further comprising:
determining the number of in-person slots and the number of virtual slots based on the member listing and one or more of member working locations, member meeting locations, the one or more paired start times and end times, or the one or more technical capabilities.

4. The method of claim 1, further comprising:
obtaining a transmission of a second data packet including the plurality of physical locations, wherein the plurality of physical locations includes availability data associated with each of the plurality of physical locations and technical capabilities associated with each of the plurality of physical locations; and
storing the second data packet in the memory.

5. The method of claim 1, further comprising:
receiving, as training data, a plurality of paired start times and end times, a plurality of in-person slots, a plurality of virtual slots, a plurality of physical locations, and a plurality of physical locations with associated technical capabilities.

6. The method of claim 1, wherein the trained machine learning model is a first trained machine learning model, the method further comprising:
determining, via a second trained machine learning model, the number of in-person slots and the number of virtual slots.

7. The method of claim 6, wherein the second trained machine learning model is trained by:
receiving, as training data, in-person data associated with an individual and virtual data associated with an individual; and
training a machine learning model, using the training data, to infer whether an individual will be in-person or virtual.

8. The method of claim 1, further comprising:
monitoring the first configuration to determine whether issue data is present; and
upon determining issue data is present, automatically determining a second configuration.

9. The method of claim 8, further comprising:
obtaining issue data related to the first configuration at a configuration system;
determining, via the trained machine learning model, a second configuration based on the issue data related to the first configuration, the first data packet, and the one or more available physical locations; and
causing to output the second configuration to the user interface.

10. The method of claim 1, further comprising:
determining, via a trained ranking machine learning model, a ranking of two or more configurations based on the first data packet and the one or more available physical locations, the ranking based on a determined configuration match to the first data packet; and
causing to output the ranking of the two or more configurations to the user interface.

11. A method for generating a first configuration, the method comprising:
obtaining a transmission of a first data packet, the first data packet including one or more paired start times and end times, a number of in-person slots, a number of virtual slots, and one or more technical capabilities;
obtaining a transmission of a second data packet, the second data packet including a plurality of physical locations, availability data associated with each of the plurality of physical locations, and technical capabilities associated with each of the plurality of physical locations;
determining, via a trained machine learning model, a first configuration based on the first data packet and the second data packet; and
causing to output the first configuration to a user interface.

12. The method of claim 11, further comprising:
receiving, from a user, a request to generate the first data packet, the request including the one or more paired start times and end times, a member listing, and the one or more technical capabilities.

13. The method of claim 12, further comprising:
determining the number of in-person slots and the number of virtual slots based on the member listing and one or more of member working locations, member meeting locations, the one or more paired start times and end times, or the one or more technical capabilities.

14. The method of claim 11, further comprising:
receiving, from a user, a request to generate the second data packet, the request including the plurality of physical locations, the availability data associated with each of the plurality of physical locations, and the technical capabilities associated with each of the plurality of physical locations.

15. The method of claim 11, further comprising:
receiving, as training data, a plurality of paired start times and end times, a plurality of in-person slots, a plurality of virtual slots, a plurality of physical locations with associated technical capabilities, the availability data associated with each of the plurality of physical locations, and a plurality of physical locations.

16. The method of claim 11, wherein the trained machine learning model is a first trained machine learning model, the method further comprising:
determining, via a second trained machine learning model, the number of in-person slots and the number of virtual slots.

17. The method of claim 16, wherein the second trained machine learning model is trained by:
receiving, as training data, in-person data associated with an individual and virtual data associated with an individual; and
training a machine learning model, using the training data, to infer whether an individual will be in-person or virtual.

18. The method of claim 11, further comprising:
monitoring the first configuration to determine whether issue data is present;
upon obtaining issue data related to the first configuration at a configuration system, determining, via the trained machine learning model, a second configuration based on the issue data related to the first configuration, the first data packet, and the second data packet; and
causing to output the second configuration to a user interface.

19. The method of claim 11, further comprising:
determining, via a trained ranking machine learning model, a ranking of two or more configurations based on the first data packet and the second data packet, the ranking based on a determined configuration match to the first data packet; and
causing to output the ranking of the two or more configurations to the user interface.

20. A system, the system comprising:
at least one memory storing instructions; and
at least one processor executing the instructions to perform operations for generating a first configuration, the operations including:
obtaining a transmission of a first data packet, the first data packet including one or more paired start times and end times, a number of in-person slots, a number of virtual slots, and one or more technical capabilities;
requesting, from a memory, one or more available physical locations based on the first data packet, wherein the one or more available physical locations is selected from a plurality of physical locations;
determining, via a trained machine learning model, the first configuration based on the first data packet and the one or more available physical locations; and
causing to output the first configuration to a user interface.
